(19) United States
(12) Patent Application Publication
(10) Pub. No.: US 2026/0066746 A1
(43) Pub. Date: Mar. 5, 2026

(54) A SENSOR DEVICE AND METHOD FOR CONTROLLING A FREE PISTON MOVER

(71) Applicant: Libertine FPE Ltd, York (GB)

(72) Inventor: Samuel Edward Cockerill, York (GB)

(73) Assignee: Libertine FPE Ltd, York, OT (GB)

(21) Appl. No.: 19/103,130

(22) PCT Filed: Aug. 10, 2023
(86) PCT No.: PCT/GB2023/052120

§ 371 Date: Feb. 11, 2025

(30) Foreign Application Priority Data
Aug. 11, 2022 (GB) 2211771.7

(51) Int. Cl. H02K 11/215; H02K 11/25; H02K 41/03

(52) U.S. Cl. CPC H02K 11/215; H02K 11/25; H02K 41/03

(57) ABSTRACT

A stator assembly for use in a linear electrical machine includes a sensor and a stator having a stator bore and at least one coil. The sensor is disposed within a coil space having a volume between an inner surface of the at least one coil and a stator bore wall. A method of controlling current in a coil of a linear electrical machine includes the linear electrical machine having a stator assembly as described.

The present invention relates to a sensor housed within the stator of a Linear Electrical Machine for measuring the position and motion of a Free Piston Mover (FPM) whether incorporated within a Free Piston Linear Generator (FPLG), a Linear Motor Reciprocating Compressor (LMRC), a Free Piston Gas Expander (FPGE), a Linear Motor Reciprocating Pump (LMRP) or a Linear Motor Reciprocating Actuator (LMRA) or other type of Linear Power System product.

These various types of Linear Power System (LPS) product, each incorporating one or more FPMs, are well known in themselves. In each case there is a Linear Electro-Mechanical System and a Linear Thermo-Fluidic System which are coupled through the linear motion of the Free Piston Mover.

Optimal system performance for such products typically requires some combination of efficiency, repeatability, precision, reliability and (in the case of Linear Power System products incorporating more than one FPM) synchronisation. Optimal system performance often depends on the precise control of FPM movement.

To date, commercial exploitation of products incorporating FPMs has remained limited due to the inadequacy of existing control methods and control systems governing piston motion to achieve optimal system performance. Piston motion control within products incorporating FPMs has been cited by experts in the field of the present invention as the most significant unresolved challenge to widespread use of products incorporating FPMs.

In addition to the control method employed for control of FPMs within Linear Electrical Mechanical Systems (LEMS) other limitations in the prior art limit the opportunity to exploit the benefits of LEM in particular to support adaptation of a reaction in a working chamber and controllable motion of the LEM and resulting compression ratio. Most notably, sensing of the parameters of motion including but not limited to position and velocity for the FPM which may typically be mechanically disconnected by any fixed linkage, and sensing the thermodynamic environment of the cylinder in which it the TPM moves and its working chamber.

For the purpose of describing the field of the invention and the background to the invention, the following terminology definitions are used:
Linear Electrical Machine (Abbreviated “LEM”): An electrical machine capable of acting as a motor or generator and which, in use, produces a linear electromagnetic force acting on a moving part or assembly within the LEM. This force may be varied by modulation of an electrical current flowing in one or more conducting coils arranged within the LEM. When acting as a motor or generator there is also relative motion between a static part or assembly within the LEM and the moving part or assembly within the LEM.
Stator: The part or assembly within a LEM which is typically static relative to the system within which the LEM operates.
Translator: the Part or Assembly Within a Lem Which Typically Moves Relative to the Stator.
Linear Electro-Mechanical System (Abbreviated “LEMS”): A physical system comprising a LEM together with other mechanical elements that may include linear bearings and seals in which forces acting on the Translator include the linear electromagnetic force applied by the LEM together with friction forces associated with the other mechanical elements, and other forces mechanically coupled from external systems.
Linear Thermo-Fluidic System (Abbreviated “LTFS”): A physical system comprising a working chamber and a moveable piston in which the volume of the working chamber is altered by the linear movement of the piston. The working chamber contains a working fluid which, through the linear movement of the piston, may be either expanded or compressed within the working chamber, or admitted into the working chamber, or displaced from the working chamber. The LTFS may also include valves for the admission and discharge of working fluid from the working chamber. The pressure of working fluid within the working chamber produces a force acting upon the piston, and this force depends on multiple factors including for example: (i) the compressibility of the working fluid, (ii) the motion of the piston, (iii) the addition or reduction of moles of fluid within the working chamber via valves within the LTFS or as a result of chemical reactions (for example combustion) or by fluid injection (for example by means of a water or fuel injector), (iv) the addition or removal of heat to/from the working chamber as a result of heat transfer to/from the working chamber walls and/or as a result of chemical reactions within the working chamber (for example, combustion between a fuel and an oxidizer) and (v) a phase change within the working fluid.
Piston: The moving component or feature within a LTFS causing a change in the volume of the working chamber volume within the LTFS
Linear Power System (Abbreviated “LPS”): A product or system comprising at least one LEMS and one LTFS in which the Translator of the LEM within the LEMS incorporates or is mechanically coupled via a fixed linkage or component to the Piston of the LTFS. In such a system the performance of the LPS is determined by the performance of the LEMS and LTFS sub-systems, and may be characterised in terms of the efficiency, repeatability, precision, reliability and durability of these sub-systems. Where the LTFS working chamber is a combustion chamber converting fuel energy into mechanical work acting upon the piston, the performance of the LPS also depends on the timing, speed and completeness of the combustion reaction and the resulting emissions formed in the working chamber gases following this reaction. The system performance of the LPS according to these characteristics depends critically on the motion of the Translator within the LEMS and the Piston within the LFTS, which are coupled together and move with a common profile of linear motion varying with time.
Free Piston Mover (Abbreviated “FPM”): The common moving part or assembly within a LPS acting as the Translator within the LEMS and acting as the Piston within the LTFS.

According to one aspect there is provided a stator assembly for use in a linear electrical machine, the stator assembly comprising: a sensor; and a stator having a stator bore and comprising at least one coil; wherein the sensor is disposed within a coil space comprising the volume between an inner surface of the at least one coil and a stator bore wall.

The present invention will now be described by way of example with reference to the accompanying drawings. In the drawings:

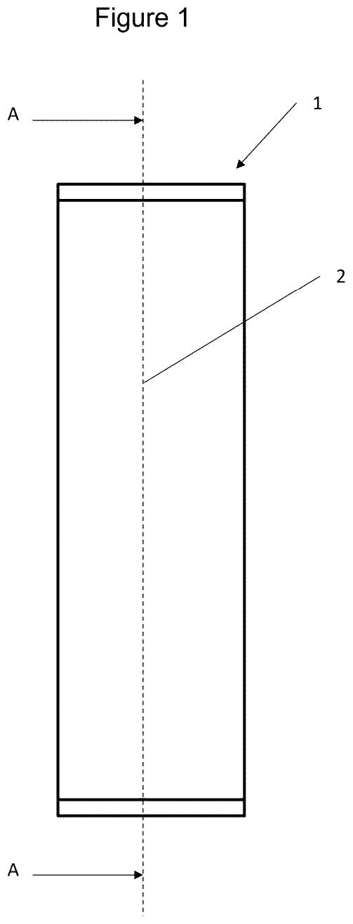

FIG. 1 shows a simplified external view of the mechanical assembly of an example of a Linear Power System.

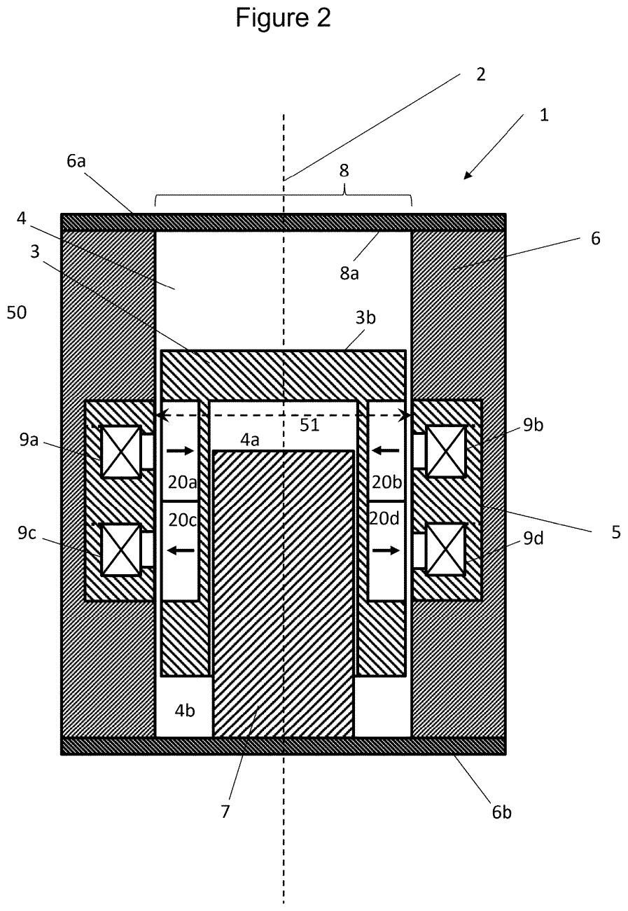

FIG. 2 shows a section view through plane AA showing the Free Piston Mover and other key features of the Linear Electrical Mechanical System.

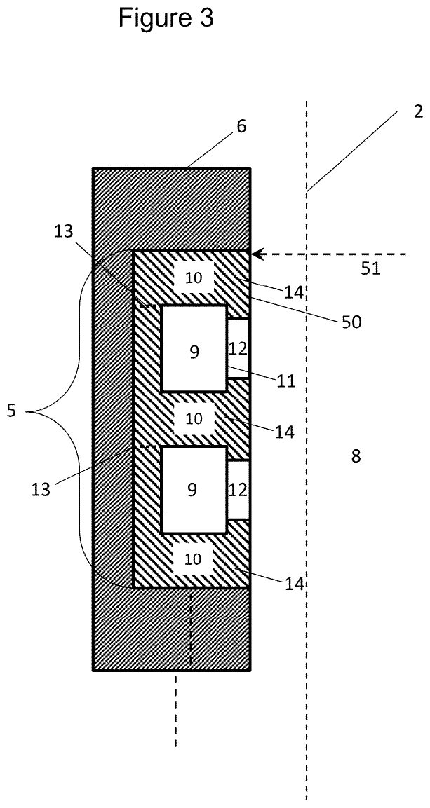

FIG. 3 Shows a Section of the Stator and Housing Body.

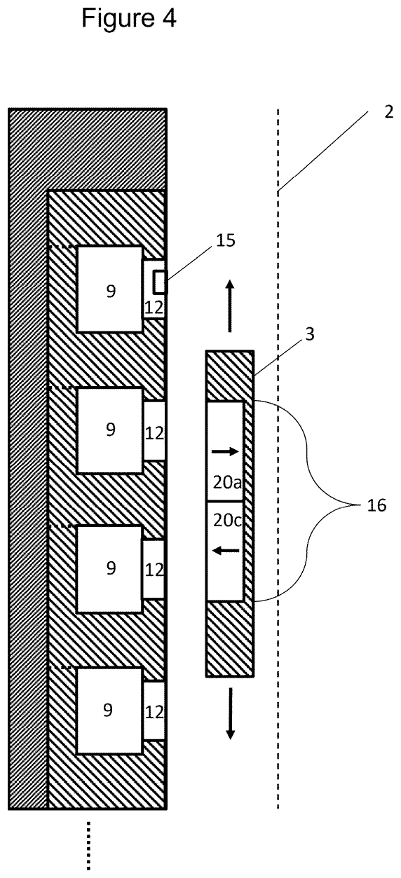

FIG. 4 shows an extended section of the stator stack.

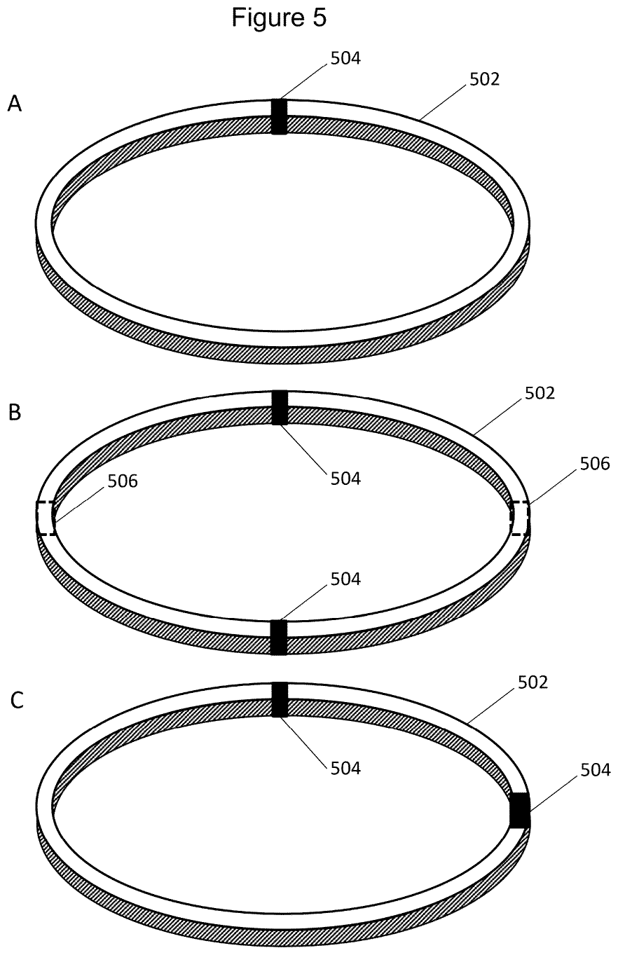

FIG. 5 shows three different configurations of sensors encased in an example retaining element.

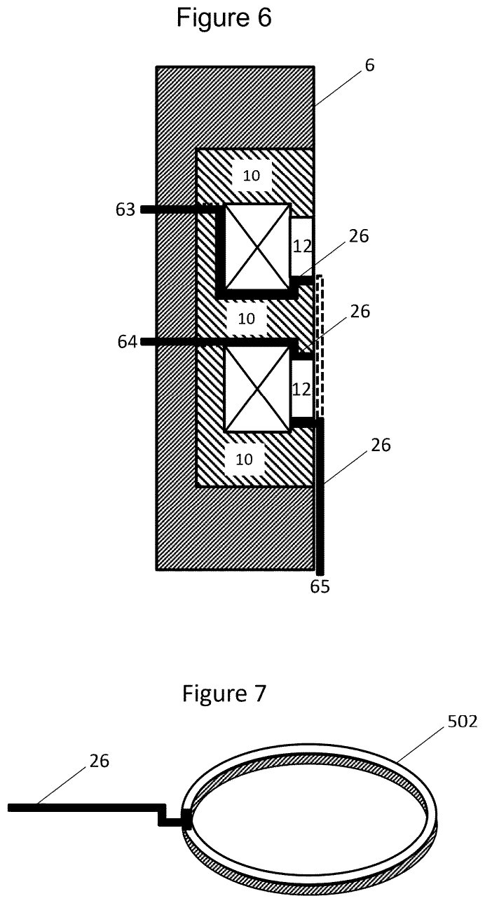

FIG. 6 shows various example options of a route for a connecting path from the one or more sensors in a coil space to a controller.

FIG. 7 shows an example of a retaining element comprising a sensor or a plurality of co-located sensors wholly encased within it and a connecting path attached to the one or more sensors.

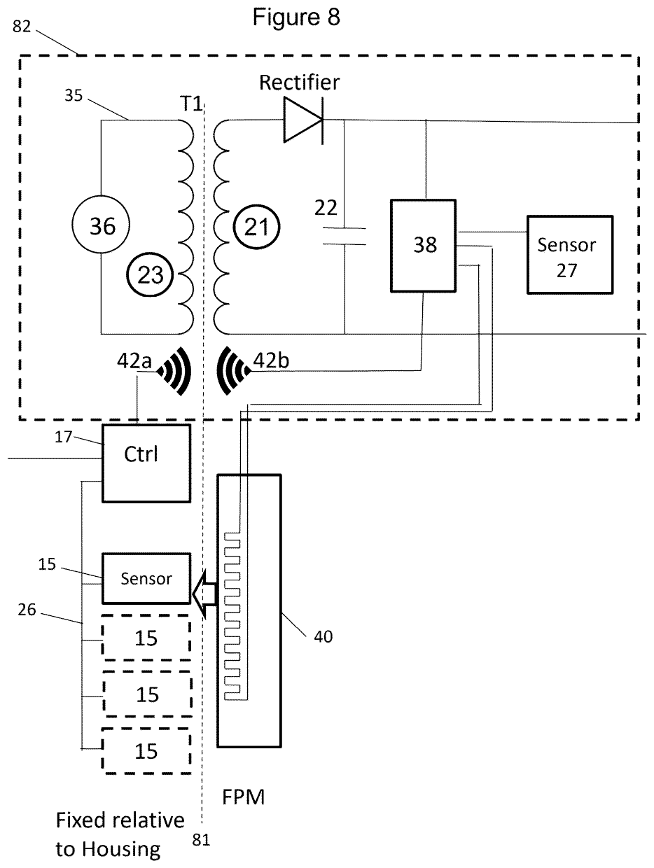

FIG. 8 shows an example electric circuit for a sensor located in the coil space of the stator.

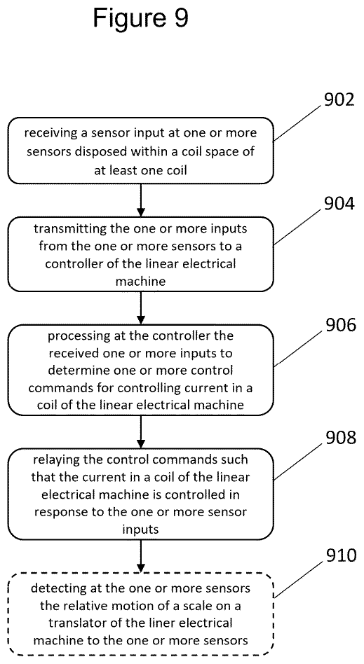

FIG. 9 shows a flow chart comprising the steps of a method of controlling current in a coil of a linear electrical machine based on a sensor input received at one or more sensors disposed within a coil space of at least one coil.

FIG. 1 is a simplified external view of the mechanical assembly of an example of a Linear Power System (LPS) 1, showing the Free Piston Mover (FPM) motion axis 2 and section plane AA.

FIG. 2 is a section view through plane AA showing the Free Piston Mover (FPM) 3 and other key features of the Linear Electrical Mechanical System (LEMS) and Linear Thermofluidic System (LTFS) within the LPS example depicted in FIG. 1. Many alternative LPS implementations are possible, each comprising at least one LEMS and one LTFS.

FIG. 2 shows the working chamber 4 of the LTFS. The LEMS includes a stator 5, and a LPS housing 6 defining a working cylinder 8. The ends of the LPS housing in this example are closed by housing end components 6a, 6b. The circumference of the working cylinder 8 may also define the diameter of the stator bore 51.

The FPM 3 acts as the translator of the LEMS. In some embodiments the translator is part of an FPM with a piston as part of a LTFS. In the example shown the FPM 3 is open at one end 3a to allow it to pass over a fixed central core 7 whilst moving within a surrounding cylinder 8 of the LPS housing 6. In this example the FPM 3 is closed at one end 3b so that a working chamber 4 is formed within the cylinder 8, and between the cylinder end wall 8a of the LPS housing end 6a and the closed end 3b of the FPM 3. The closed end 3b facing the working chamber may be referred to as the piston crown 24 which may be part of the main bulk of the FPM 3 as indicated in FIG. 2 for simplicity or a separate attached part or subassembly that is attached to FPM 3.

In a LPS application such as a Free Piston Linear Generator (also known as a Free Piston Engine) or Free Piston Gas Expander, the working chamber 4 may be used to apply a force on the closed end 3b of the FPM 3 by combustion, by introduction of a high pressure gas, or by a phase change. The associated features that may be included within these types of LPS (for example fuel and air supply, valves and ignition features) are not shown for clarity.

In the example embodiment shown in FIG. 2, two further volumes 4a, 4b are defined between the central core 7 and the FPM 3, and at the open end of the FPM 3a. Each may act as a bounce chamber in which changes in pressure within these chambers 4a, 4b caused by the movement of the FPM 3 result in the exchange of energy between the kinetic energy of the FPM 3 and energy stored in the compressed gas within the bounce chambers 4a, 4b.

The FPM 3 is formed with a translator 16 configured to include one or more magnetically permeable or magnetised elements 20 which interact with stator 5 to influence the current flowing within the stator 5 and produce or vary a linear electromagnetic force acting on the FPM 3.

When the LPS 1 acts as a type of linear motor or actuator, electrical power input to the stator 5 causes relative motion of the translator 16 and thus motion of the FPM 3. When the LPS 1 acts as a type of linear generator, electrical power output from the stator 5 is produced by relative motion of the translator 16 as part of the FPM 3.

When the working chamber 4 acts as a combustion chamber converting fuel energy into mechanical work acting upon the FPM 3, the performance of the LPS depends on the timing, speed and completeness of the combustion reaction and the resulting emissions remaining in the working fluid following this reaction. The system performance of the LPS according to these characteristics depends critically on the linear motion profile of the FPM 3 with time.

FIG. 2 shows the magnetically permeable or magnetised elements 20 which form the translator 16 and are shown aligned with the upper and lower limits of the stator 5. The features 20a and 20b in this example illustrate sections through a single ring of magnetically permeable material. However, 20a and 20b may alternatively be separate elements. Similarly in this example, 20c and 20d depict sections of a further ring of magnetically permeable material but may also alternatively be comprised of separable elements. It can be seen by the arrows that the material 20a/b and material 20c/d are polarised in different orientations. Whilst the arrows indicate here that they are in opposite polarity the axis of polarisation may be any angle and indeed may rotate at an angle less than 180 degrees and preferably less than 90 degrees along a line of such magnetically permeable or magnetised sections of material.

The stator 5 may comprise a plurality of cylindrical elements stacked together to form a stator assembly. Among these elements are one or more stator coils 9. A coil may be described as a conductor enclosing an area with one or more turns such that a change in the flux within the enclosed area results in an induced voltage across the terminals of the coil. The coil may be formed of turns of individual conductors or of stranded conductors. The cross-section of the turns of the conductors may be round, square, rectangular or other shaped cross-section. The turns forming a coil may be continuous or joined. The features 9a and 9b in this example illustrate sections through a single coil 9 of the stator 5. Similarly in this example, 9c and 9d depict sections of a further coil 9 of the stator 5. Among the components stacked to form the stator assembly are one or more stator body elements 10.

FIG. 3 shows a section of the stator 5 and housing body 6 as shown in FIG. 2 in greater detail. The axis of motion 2 of the FPM 3 is shown on the right-hand side of the figure. The section includes part of the housing body 6, which is simplified to assist in illustrating and describing the following features. The section also comprises part of the stator 5 which in turn comprises the sections 9a and 9c described above. It should be understood that the sections of stator 5 and housing body 6 may be extended to include further stator coils 9 and stator body elements 10 as necessary for the desired LEM construction.

A stator bore 51 may be defined by the internal cylindrical void within the stator assembly. In the example shown a stator bore wall 50 is defined by the inner surface of the stator body elements 10. There may also be a housing body wall (not shown) between the inner surface of the stator body elements 10 and the working cylinder 8, as such the stator bore wall 50 may be defined by the inner surface of the housing body wall facing the working cylinder 8.

As mentioned above, the stator assembly may comprise a plurality of sections arranged to stack one on top of the other. A coil 9 may be positioned in between each respective stator body element 10 of the stack. The stator body elements 10 may be shaped to provide recesses within which the neighbouring one or more coils 9 can sit. The stator body elements 10 may be arranged to make contact with the next respective element 10 in the stack at the outermost edge of the stator circumference, as shown in FIG. 3. The dotted lines 13 show where one stator body element 10 of the stator makes contact with the next stator body element 10 in the stack.

The stator body elements 10 are shaped such that a portion of each stator body element 10 protrudes around the side of a neighbouring coil and toward the motion axis 2. These protruding portions may be referred to as teeth, where a single stator body element 10 as shown in this example has a single tooth portion 14. Typically, a single coil 9 will be flanked by two stator body elements 10 each with a respective tooth 14.

The coils 9 are positioned within the stator 5 such that an airgap is created at a position around the circumference in a vertical plane of the coil 9. That is, for example, at a position around the circumference of the coil sections 9a and 9c as shown in FIG. 3. The airgap is maintained at all points radially around the circumference in the horizontal plane of the coil 9. It is important to maintain this airgap in order to have directional control of the flow of magnetic flux through the stator body elements 10 when current flows through the coils 9. The airgap need not contain air, but this the magnetic permeability of this volume should be lower than that of the stator body elements. This volume will be referred to herein as the coil space 12 or coil root space. The coil space 12 may contain a sensor.

There is therefore proposed herein a stator assembly for use in a linear electrical machine, the stator assembly comprising a sensor and a stator, the stator having a stator bore and comprising at least one coil. The sensor is disposed within a coil space comprising the volume between an inner surface of the at least one coil and a stator bore wall.

The coil space 12 is therefore a radial volume defined by an inner surface 11 of the coil 9, and a wall 50 of the stator bore 51. A first and second tooth 14 of two stator body elements 10 may form the upper and lower bounds of the coil space 12. In the example shown in FIG. 3 the respective teeth of the two stator body elements 10 extend toward the motion axis 2 and beyond the coil 9 to define the top-most and bottom-most sides of the coil space 12. Thus, the stator may comprise a first tooth and a second tooth and the sensor may be disposed within the coil space bounded by the first tooth and second tooth of the stator.

The coil space 12 may therefore be described as doughnut-like or ring-like in shape. The coil space 12 is typically filed with an electrically insulating material. In this example the translator 16 and FPM 3 are not shown.

FIG. 4 shows an extended section of the stator stack compared to that shown in FIG. 3. FIG. 4 also includes a section of the FPM 3. The section of the FPM 3 shows a portion of the translator 16 and related features for providing the functionality of a LEMs.

As mentioned above, the coil space 12 next to any of the one or more coils 9 may house a respective sensor 15. The sensor 15 may be of any type and may be sensitive to the relative motion of the translator 16. The one or more sensors may comprise a Hall Effect sensor, a temperature sensor, a capacitive sensor, an Anisotropic Magnetic Resistance, AMR, sensor, an optical sensor, an inductive sensor, or any combination thereof.

Each of these sensors can be arranged to detect a different attribute. These different attributes may each be used to determine one or more states of the system. For example, a Hall effect sensor may be used to determine the local magnetic flux field magnitude or angle.

The one or more sensors in a coil space can be used to provide a scale input to a controller 17. The plurality of sensors 15 may be located in a plurality of coil spaces 12. The scale input may be provided from a single sensor 15. For example, a single hall effect sensor may provide a reading of magnetic flux and/or magnetic field angle from which the location of the translator along the stator bore may be determined. Similarly, a plurality of sensors 15 may be used to provide a series of inputs to a controller 17. The plurality of sensors 15 may provide different types of input. For example, readings of magnetic flux and temperature.

Alternatively or additionally, a plurality of sensors 15 may be used to provide a plurality of readings of the same attribute from different locations within the stator bore. For example, a plurality of hall effect sensors in coil spaces 12 at differently spaced locations along the stator bore and the axis of motion 2 of the translator may provide different respective readings. These readings can be used to obtain information about the position of the translator along the stator bore. As the distance between the sensors in the various coil spaces is known, and the response of each of the hall effect sensors as the translator passes it has been mapped, the combination of readings from a plurality of hall effect sensors may be used to determine the position of the translator inside the stator bore. For example, a proportion of the one or more sensors may be Hall Effect sensors arranged to detect a scale provided by one or more magnets or magnetically permeable components on a translator of the linear electrical machine. A single magnet may provide a scale to be detected by the sensor as one magnet presents a distribution of field magnitude and angle that varies according to the relative location of the measurement.

Other types of sensors 15 may be used in the same way to determine the position of the translator, such as one or more capacitive sensors, AMR sensors, or inductive sensors, as appropriate. For example, a proportion of the one or more sensors referred to above may be temperature sensors. In another example, a proportion of the one or more sensors may be anisotropic magnetic resistance, AMR, sensors arranged to detect a scale provided by one or more magnets on a translator of the linear electrical machine. In yet another example, a proportion of the one or more sensors may be capacitive sensors, inductive sensors, or optical sensors, or any combination thereof and may be arranged to detect a scale provided by a passive electrical device or circuit, a powered electrical circuit, a series of magnets, or a series of differently optically reflective marks respectively on a translator of the linear electrical machine. Examples of a passive electrical device are those which have a similar operation to an RFID tag or contactless payment card. For example, current in an unpowered circuit on the translator may flow in response to an externally applied electro-magnetic field at one location, resulting in an apparent and measurable change in an electro-magnetic field at another location.

A plurality of temperature sensors 15 positioned in one or more coil spaces 12 may allow for reliable temperature readings or estimates within the stator bore or working chamber 4. A plurality of temperature readings from sensors 15 located in a plurality of coil spaces 12 may allow for the temperature of the environment within the stator bore and working chamber(s) to be monitored in real time or modelled in 3-dimensions or both. A single coil space 12 may comprise a plurality of temperature sensors 15. For example, three temperature sensors may be used in a single coil space 12. That is, it's better to have two sensors rather than just one sensor, in case one sensor is wrong or faulty or broken or breaks. It's even better to have three sensors so that if one breaks there are still two sensors for comparison.

Therefore, by placing one or more sensors in one or more coils spaces it is possible to control the current in a coil of a linear electrical machine. The linear electrical machine comprises a stator assembly as described above and the method comprises receiving a sensor input at one or more sensors disposed within a coil space of at least one coil; transmitting the one or more inputs from the one or more sensors to a controller of the linear electrical machine; processing at the controller the received one or more inputs to determine one or more control commands for controlling current in a coil of the linear electrical machine and; relaying the control commands such that the current in a coil of the linear electrical machine is controlled in response to the one or more sensor inputs. As such the control of the current also enables the control of the motion of the translator 16 and associated FPM 3. The better the control of the motion of the translator 16 and FPM 3 the more energy efficient the linear electrical machine.

The stator assembly may comprise one or more further sensors and one or more further coils, each sensor being disposed in the coil space of a coil of the plurality of coils. Accordingly, the plurality of sensors may be arranged to provide one or more signal inputs to a controller to determine one or more of: the proximity, the axial location, the axial velocity and/or the axial acceleration of a translator within the stator bore, the associated local magnetic flux field magnitude or local magnetic local flux angle, and/or the local temperature of the translator. For example, the sensors may provide one or more signal inputs to the controller from which the controller may determine the axial velocity of the translator. The controller may alternatively or additionally receive one or more signal inputs from the plurality of sensors to determine the proximity of the translator from an end of the working cylinder. Alternatively or additionally, the plurality of sensors may provide one or more signal inputs to the controller to determine the associated local magnetic flux field angle in the vicinity of the plurality of sensors. It should be understood that the example quantities listed above may also be determined based on one or more signal inputs received from a single sensor where possible. That is, for example, a single temperature sensor may provide a single input signal to the controller to determine the local temperature of the translator.

The one or more sensors in any one coil space may be prevented from being inadvertently removed from the coil space 12 by a coil space element 502. The coil space element 502 may partially or wholly encase one or more sensors, such that the coil space element is a retaining element, specifically one that engages with and holds at least part of the senor. A retaining element may partially or wholly fill a coil space. Thus, the sensor is contained within a retaining element within the coil space 12. Alternatively, the coil space element 502 may simply fill sufficient space with the coil space 12 to prevent the sensor(s) from falling out. The coil space element may abut one or more sensors or may be spaced from one or more sensors. The coil space element may be shaped to hold, contact or otherwise support one or more sensors. In this example, the coil space element may also function to retain the sensor(s) in place, but may also act to prevent access to one or more sensors that are otherwise mounted within the coil space. In either example, the coil space element is considered to be a retaining element and, unless explicitly stated, the term retaining element covers both types of coil space element described above.

FIG. 5 shows three different configurations of sensors encased in an example retaining element.

FIG. 5A shows an example retaining element 502 with a single embedded sensor 504. The sensor 504 may be partially or wholly encased or embedded in the retaining element 502. The retaining element 502 is shaped to fit within the coil space 12. The retaining element 502 may take up only a portion of the coil space 12. For example, the retaining element 502 may be shaped to fill the lower half of the coil space 12, or the retaining element 502 may be shaped to fill the outermost half of the coil space 12 radially outward from the axis of motion 2. Other divisions of the coil space 12 proportionally and dimensionally can be chosen to be filled by the retaining element as required. In any respect, the retaining element circumscribes the stator bore wall within the coil space. The retaining element may also form a seal between adjacent stator teeth/stator body elements. This seal prevents leakage between the working cylinder and the stator through the coil space.

FIG. 5B shows an example retaining element 502 for filling a single coil space having two embedded sensors 504. The sensors 504 may be positioned within the coil space with any relative spacing and with any orientation of the retaining element. For example, by rotating the retaining element in FIG. 5B by 90 degrees about the axis of motion 2 in a clockwise direction the two sensors 504 may be positioned at 3 o'clock and 9 o'clock positions shown by dotted rectangles 506 instead of the 12 o'clock and 6 o'clock positions as shown. Orientation of the retaining element within the coil space may be dependent on the rotational symmetry of the cylindrical stator bore. In this example the stator bore is circular in circumference, but other shapes such as square or hexagonal could be envisioned. The positions 506 could be filled by two further sensors such that the retaining element 502 holds four sensors. In FIG. 5B these four sensors would be equally spaced from each other around the circumference of the retaining element.

The relative spacing of the sensors 504 in the retaining element 502 of FIG. 5B is symmetrical and equidistant. However, as illustrated in FIG. 5C, the relative spacing of sensors within the coil space may be asymmetrical and not equally spaced. Any number of sensors could be placed into a single coil space 12, space permitting, and any combination of relative spacing could be achieved around the circumference of the stator bore. Therefore, the retaining element may comprise a plurality of sensors positioned around its circumference.

The stator assembly may comprise one or more further sensors and one or more further coils, each sensor being disposed in the coil space of a coil of the plurality of coils. Sensors may be arranged differently in different coil spaces simply by changing the orientation of the retaining element by rotation around the axis of motion 2. Thus, the retaining elements themselves may have the same configuration regarding the internal spacing of the embedded sensors, but the relative location within the stator bore across a plurality of coil spaces may allow for various sensor arrangements. For example, it may be possible to create single or double helix sensor arrays simply by relative rotation of retaining elements and their respective sensors. A proportion of the one or more sensors may comprise a Hall effect sensor and temperature sensor combined into a single sensor unit. The single sensor unit may be placed at a single location on the circumference of the retaining element. Multiple sensor units may be placed at the same or different locations on the circumference of one or more retaining elements.

The retaining element may comprise any material having the required physical properties needed to create an airgap, withstand the temperatures within and close to the stator bore, and able to partially or wholly encase the one or more sensors. The retaining element may therefore be comprised of one or more components formed of ceramic material, high temperature thermoplastic polymer such as PTFE, or high temperature thermosetting resins such as epoxy, polyimides, and phenolic compounds. A resin may be used to incorporate the one or more sensor elements together with conducting elements into a separate retaining element, or may be used to incorporate a retaining element that is bonded by the resin to the coil or otherwise within the stator.

FIG. 6 shows various options for a route for a connecting path 26 from the one or more sensors in a coil space to a controller. That is, each of the one or more sensors may be electrically connected to a controller via an electrically conductive connecting path. The connecting path may comprise a wire, or a ribbon, or an electrically conductive track on a flexible printed circuit board, capable of transmitting data values or one or more signals detected at the sensor to the controller.

The connecting path itself may run from the coil space where the one or more sensors are located to the controller. The controller may be located externally from the stator assembly and may be located externally from the LEM altogether. As such, the connecting path may run from the one or more sensors located within the coil space to a controller (not shown) located outside of the housing body 6.

As shown in FIG. 6, there are a plurality of possible routes the connecting path could take. The first example route 63 runs from the sensor in the coil space 12 along the underside of the coil, through a gap between adjacent stator body elements 10 in the stator assembly or stack and through a void in the housing body 6. The second example route 64 runs from the sensor in the coil space 12 across the upper side of the coil, through a gap between adjacent stator body elements 10 in the stator assembly or stack and through a void in the housing body 6. In both of the routes 63 and 64 the connecting path runs from the one or more sensors between the respective coil and an adjacent tooth of the stator to the controller.

The third example route 65 runs from the sensor in the coil space 12 along the face of the stator bore wall. The connecting path may then exit the stator assembly at an end of the stator bore (not shown) and connect with a controller.

The gap between stator body elements 10 in the stator assembly may be a pre-existing gap that exists due to the manufacturing and construction of the stator assembly. That is, a pre-existing gap or join between the stator body elements 10 in the stator assembly may be utilized for passing a connecting path through without having a detrimental effect on the stator assembly construction or functionality. Alternatively, a purpose built gap or void may be implemented within the stator assembly, either within a single stator body element 10 or at the join between two adjacent stator body elements 10. For example, a groove may be cut or molded into the adjoining surfaces of one or both of the neighbouring stator body elements 10 to provide a gap or void through which the connecting path may be placed.

The void in the housing body may be purpose built to allow for a connecting path from the sensors to an external controller. The void in the housing body 6 may be a consequence of the manufacturing process of the housing body and subsequently re-purposed to allow for the connecting path to exit the housing body 6.

The connecting path may be a ribbon or a wire or a track on a flexible printed circuit board. The ribbon or wire or track may be made of copper or any other electrically conductive material suitable for transmitting electrical signals or data. A wire may have a higher profile or larger cross-section than the ribbon or track to accommodate between stator body elements 10 of the stator assembly, but it may be cheaper to implement. A ribbon or track connecting path may have a lower profile than a wire to accommodate between stator body elements 10 of the stator assembly, but it may also be more expensive and fragile to implement.

FIG. 7 shows an example of a retaining element comprising a sensor or a plurality of co-located sensors wholly encased within it and a connecting path attached to the one or more sensors. Such an item may be constructed separately and placed into one or more coil spaces as required during the construction of the stator assembly. As shown in FIG. 5, the retaining element may house one or more sensors at one or more locations around the circumference of the retaining element. It should be understood that connecting paths may be attached to or enclosed within the retaining element as required to provide the necessary connections between one or more sensors and a controller. The connecting path may be partially encased within the retaining element. Alternatively or additionally, a join between the sensor and the connecting path may be encased within the retaining element.

FIG. 8 illustrates an example electric circuit for sensor 15 located in the coil space 12 of the stator 5. The sensor 15 is connected to the controller 17 via a connecting path 26 (for example, any of paths 63, 64, 65 illustrated in FIG. 6). As the translator 5 moves past the sensor 15 the output reading or signal generated by the sensor is communicated from the sensor 15 to the controller 17 via the connecting path 26. The sensor input to the controller may then be used to control the motion of translator relative to the stator 5 by altering the current that flows around each of the coils 9 of the stator 5.

There may be a plurality of sensors 15 located in adjacent coil spaces as indicated by dashed line boxes. All of these sensors 15 may in turn be connected to controller 17 along respective connecting paths 26 (for example, paths 63, 64, 65 illustrated in FIG. 6). The controller may have an internal or external power source to which it may be connected for the purposes of powering the one or more sensors 15.

Optionally, additional circuitry may be added to provide power to an electronic circuit on the FPM 3. In the case where there is an active scale 40 provided on the translator, elements which make up this active scale may require a power supply. This can be provided by implementing the circuitry as shown within the dashed line 82 in FIG. 8. Box 82 comprises optional additions including a data transmitter and or data receiver which may support communication, preferably serial data communication, between cooperating circuits of on the FPM 3 and the LPS housing 6. These are preferably wireless due to the relative motion of the FPM and the LPS housing. Some aspects of the data transmitter and data receiver may be second functions of some aspects of the power transmitting means and power receiving means. For example, they may share common coupling coils which are aligned for at least a part of the LPM motion along the motion axis 2. There are many alternative implementation approaches that may be employed for data communication between the LPS housing 6 and the FPM 3.

Box 82 of FIG. 8 also comprises a transformer T1 which is formed in two parts where for at least a part of the stroke of the FPM the stator circuit 35 becomes aligned with power receiving means 21. The stator circuit 35 and power receiving circuit 21 are shown here as primary and secondary coils of the transformer T1. The switch 36, for example an H-bridge, switches current in the primary stator circuit 35 which is transformed to the secondary-side coil to give an alternating current. The alternating current may be rectified to a DC supply by a rectifier shown here for simplicity as a half-wave rectifier but preferably being implemented as a full wave rectifier. The rectified output of the rectifier supplies the energy storage means 22. T1 need not be a high voltage transformer being provided to supply power that may be rectified to a DC voltage to supply the components on the FPM, optionally with voltage regulation not shown. A dashed line is illustrative of an air gap 81 between the fixed housing and the FPM.

FPM electrical circuitry may also comprise controller means 38; which may be for example, logic, analogue electronics, or a microcontroller circuit executing embedded firmware and managing one or more sensors 27 and or data communication to the fixed housing circuits.

Data communication means 42 formed of receivers, transmitters or transceivers 42a and 42b providing communication to and or from the fixed controller 17 and the FPM controller 38. 42a and 42b are illustrated as a radio frequency point to point communication path but may alternatively be inductive coupled devices or magnetically coupled devices or optically coupled devices. Further the data communication means 42a and or 42b may be independent or combined with power transmitter stator circuit 35 and or power receiving means 21.

A power receiving means 21 is also shown and is formed within or attached to the FPM 3, in this example as a coil about the motion axis 2. The at least one power receiving means is disposed to cooperate with at least one power transmitting means 23 located in the LPS housing 6. The FPM 3 is shown at a position along the LPS motion axis 2 causing the power transmitting means 23 and the power receiving means 21 are shown to be aligned such that the transfer of power is supported as if in a transformer. Depending on position of the FPM along the motion axis power transmitting means 23 and power receiving means 21 may spend periods of time during some or all strokes where they are out of alignment and unable to exchange power. However, in alternative configurations the geometry of the design and FPM motion range may facilitate continuous power exchange.

FIG. 8 also shows an energy storage means 22 on board the FPM. The energy storage means 22 may be for example but not limited to a capacitor, super-capacitor (also known as a “super-cap”) or a battery or one or more cells of a battery. The energy storage means 22 may be disposed to move with the FPM 3 making power available throughout its stroke, especially when the power receiving means 21 is not presently coupled to a power transmitting means 23, thereby affording power to be made available to onboard combustion initiation means and sensors, etc. Additionally, the energy storage means may be required to provide power with high levels of electrical current, in particular but not limited to combustion initiation means (not shown). Sensor(s) 27 and combustion initiation means may be powered by the power coupling means.

Active scale 40 comprises a circuit element for example a printed pattern on a printed circuit board or flexible circuit or graphene either patterned or connected to a matrix of connections carrying signals; a material of varying electrical properties such as magnetically permeable material or network of components; any of which or in combination may be energized in a constant or varying manner under control of controller 38 so as to cause a varying electric and or magnetic field along its length.

Disposed on or within the outer surface of FPM 3 the active scale 40 it is preferably orientated so that the varying electric and or magnetic field intersects with scale sensor 39 for example a Hall-effect device in the fixed housing and connected to or integrated with the controller 37. By the arrangement described the controller 37 may monitor and detect the motion of the FPM allowing synchronized control of its motion and events including but not limited to timing of combustion initiation including by employing combustion initiation means.

FIG. 9 shows a flow chart comprising the steps of a method of controlling current in a coil of a linear electrical machine based on a sensor input received at one or more sensors disposed within a coil space of at least one coil. The method comprises, at step 902, receiving a sensor input at one or more sensors disposed within a coil space of at least one coil. The coil being a coil within the stator of the linear electric machine.

The next step 904 comprises transmitting the one or more inputs from the one or more sensors to a controller of the linear electrical machine. Following this, step 906 comprises processing at the controller the received one or more inputs to determine one or more control commands for controlling current in a coil of the linear electrical machine. The next step 908 comprises relaying the control commands such that the current in a coil of the linear electrical machine is controlled in response to the one or more sensor inputs. For example, the input may indicate that the speed of the FPM is faster than desired, as a result the current in a coil of the linear electric machine can be altered such that there is a reduction in speed of the FPM.

The transmitting may be via an electrically conductive connector electrically connected between each of the one or more sensors and the controller. This connector may run along the connecting path 26 referred to above.

In an embodiment, the step 910 of receiving a sensor input may comprise detecting at the one or more sensors the relative motion of a scale on a translator of the linear electrical machine to the one or more sensors. The scale may be passive or active, and arranged or created as described above.

The method may also comprise any one or more of the following steps as necessary: amplifying one or more analogue output signals; filtering one or more analogue output signals; converting at least one analogue output signal to a digital output signal; adjusting an analogue or digital signal arising from one or more sensors in a particular coil space to take account of the current flowing in a corresponding adjacent coil; combining two or more analogue or digital signals arising from one or more sensors in two or more respective coil spaces to create a hybrid analogue or digital signal; determining a measured magnetic flux angle or a measured magnetic flux magnitude in the coil space of the at least one coil based on at least one sensor input and resulting single analogue or digital signal or a hybrid analogue or digital signal; determining a measured translator position based on an output analogue or digital signal or a hybrid analogue or digital signal; differentiating the measured translator position to determine a measured translator velocity; determining a target velocity based on the measured translator position; determining a target linear electric machine force based on the difference between the target velocity and the measured translator velocity; determining a target linear electric machine current for each coil based on the target linear electric machine force and the measured translator position; determining a target linear electric machine current for at least one coil based on the target linear electric machine force and the measured magnetic flux angle or measured magnetic flux magnitude in the coil space of the coil.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A stator assembly for use in a linear electrical machine, the stator assembly comprising:
a sensor; and
a cylindrical stator having a stator bore and comprising at least one cylindrical coil;
wherein the sensor is disposed within a coil space comprising the volume between an inner surface of the at least one coil and a stator bore wall defined by the inner surface of the stator.

2. The stator assembly according to claim 1, wherein the stator comprises a first tooth and a second tooth and the sensor is disposed within the coil space bounded by the first tooth and second tooth of the stator.

3. The stator assembly according to claim 1, wherein the sensor is retained within the coil space by a coil space element.

4. The stator assembly according to claim 3, wherein the coil space element is a retaining element and the sensor is contained within the retaining element within the coil space.

5. The stator assembly according to claim 4, wherein the retaining element circumscribes the stator bore wall within the coil space and forms a seal between adjacent stator teeth.

6. The stator assembly according to claim 5, wherein the retaining element comprises a plurality of sensors positioned around its circumference.

7. The stator assembly according to claim 1, wherein the stator assembly comprises one or more further sensors and one or more further coils, each sensor being disposed in the coil space of a coil of the plurality of coils.

8. The stator assembly according to claim 7, wherein the plurality of sensors are arranged to provide one or more signal inputs to a controller to determine one or more of: the proximity, the axial location, the axial velocity and/or the axial acceleration of a translator within the stator bore, the associated local magnetic flux field magnitude or local magnetic local flux angle, and/or the local temperature of the translator.

9. The stator assembly according to claim 1, wherein the one or more sensors are electrically connected to a controller via an electrically conductive connecting path.

10. The stator assembly according to claim 9, wherein the connecting path includes an electrically conductive track on a flexible printed circuit board.

11. The stator assembly according to claim 9, wherein the connecting path runs from the one or more sensors between the respective coil and an adjacent tooth of the stator to the controller.

12. The stator assembly according to claim 9, wherein the connecting path is partially encased within the retaining element.

13. The stator assembly according to claim 9, wherein at least a join between the sensor and the connecting path is encased within the retaining element.

14. The stator assembly according to claim 7, wherein a proportion of the one or more sensors are Hall Effect sensors arranged to detect a scale provided by a one or more magnets or magnetically permeable components on a translator of the linear electrical machine.

15. The stator assembly according to claim 1, wherein one or more of the sensors are temperature sensors; or
one or more of the sensors are anisotropic magnetic resistance, AMR, sensors arranged to detect a scale provided by one or more magnets on a translator of the linear electrical machine.

16. (canceled)

17. The stator assembly according to claim 1, wherein one or more of the sensors are capacitive sensors, inductive sensors, or optical sensors, or any combination thereof and arranged to detect a scale provided by a passive electrical device or circuit, a powered electrical circuit, a series of magnets, or a series of differently optically reflective marks respectively on a translator of the linear electrical machine; or
a proportion of the one or more sensors comprise a Hall effect sensor and temperature sensor combined into a single sensor unit.

18. (canceled)

19. A method of controlling current in a coil of a linear electrical machine, the linear electrical machine comprising a stator assembly according to any or the preceding claims, the method comprising:
receiving a sensor input at one or more sensors disposed within a coil space of at least one coil;
transmitting the one or more inputs from the one or more sensors to a controller of the linear electrical machine;
processing at the controller the received one or more inputs to determine one or more control commands for controlling current in a coil of the linear electrical machine; and;
relaying the control commands such that the current in a coil of the linear electrical machine is controlled in response to the one or more sensor inputs.

20. The method of claim 19, wherein the transmitting is via an electrically conductive connector electrically connected between each of the one or more sensors and the controller.

21. The method of claim 19, wherein the step of receiving a sensor input comprises detecting at the one or more sensors the relative motion of a scale on a translator of the linear electrical machine to the one or more sensors.

22. The method of claim 19, wherein the processing comprises one or more of the steps;
amplifying one or more analogue signals output from a sensor;
filtering one or more analogue signals output from a sensor;
converting at least one analogue output signal to a digital output signal;
adjusting an analogue or digital signal arising from one or more sensors in a particular coil space to take account of the current flowing in a corresponding adjacent coil;
combining two or more analogue or digital signals arising from one or more sensors in two or more respective coil spaces to create a hybrid signal;
determining a measured magnetic flux angle or a measured magnetic flux magnitude in the coil space of the at least one coil based on at least one sensor input and resulting single analogue or digital signal or a hybrid signal;
determining a measured translator position based on an output analogue or digital signal or a hybrid signal;
differentiating the measured translator position to determine a measured translator velocity;
determining a target velocity based on the measured translator position;
determining a target linear electric machine force based on the difference between the target velocity and the measured translator velocity;
determining a target linear electric machine current for each coil based on the target linear electric machine force and the measured translator position; and
determining a target linear electric machine current for at least one coil based on the target linear electric machine force and the measured magnetic flux angle or measured magnetic flux magnitude in the coil space of the coil.
